(19) United States
(12) Patent Application Publication
(10) Pub. No.: US 2004/0010417 A1
(43) Pub. Date: Jan. 15, 2004

(54) Method and apparatus for supporting electronic content distribution

(76) Inventor: Ariel Peled, Even-Yehuda (IL)

Correspondence Address: Anthony Castorina, G E Ehrlich (1995) Ltd, Suite 207, 2001 Jefferson Davis Highway, Arlington, VA, 22202, US

(21) Appl. No.: 10/398,514

(22) PCT Filed: Oct. 16, 2001
(86) PCT No.: PCT/IL01/00956

(30) Foreign Application Priority Data
Oct. 16, 2000 (US) 60240093

(51) Int. Cl. G06F 17/60

(52) U.S. Cl. 705/1; 707/10; 707/3

(57) ABSTRACT

Network interactive distribution auxiliary apparatus for association with content distribution over a network from content sources in accordance with user requests to content distribution sites, said content being held in content holding sites, said apparatus comprising: a database for holding data of placement of content around said content holding sites, a request receiver for receiving requests for said placement data from said content distribution sites, and a content distribution co-ordinator, associated with said database for sending said placement data to said distribution sites to enable said distribution sites to supply said content via said content holding sites.

### FIELD OF THE INVENTION

The present invention relates to a method and apparatus for supporting the distribution of products, services and especially electronic content over a network, and more particularly but not exclusively to electronic information analysis in the field of online purchase/usage information analysis in general.

### BACKGROUND OF THE INVENTION

Methods for analyzing market needs are well known in the prior art. The scientific field of econometrics deals with measuring market behavior according to certain phenomena/criteria. Existing patents and applications deal with the gathering of approved purchase requests, storing them in databases and analyzing personal, organizational and market behavior regarding those requests. There are methods, commonly referred to as “data mining techniques”, that analyze both approved and denied requests in order to find patterns of fraudulent behavior and churn hazards and which are even able to build marketing rules accordingly.

One of the problems in content distribution over the Internet is bottlenecks. Retailers are not always ideally situated or have the capacity to supply content to users wherever they are located. Internet resources are more efficiently utilized when the bulk of the content is located close to the consumers. Nevertheless, content distribution websites do not have the capacity to have large numbers of locations around the Internet.

In certain cases, there arises the need to deny service, for example, when suspicious behavior is indicated, or where particular content is not approved for distribution in a particular country or to a given age group. In general, however, denial of a service represents lost revenue potential, as well as damage to the reputation and market share of a given company, in particular when the denial of service is widespread and avoidable and where competition (legitimate or otherwise) is involved.

Traditionally, systems and methods such as data mining have been used to formulate generalized rules based on statistical analysis of the data group (e.g. past fraudulent experiences correlated to specific data patterns). The rules have then been implemented on new data to assess the likelihood of that data belonging to a specific subgroup (such as fraudulent activity in the above example).

However, sometimes there is a need to analyze the data for other purposes, such as for general marketing and sales information.

In product or service marketing and sales, there is sometimes a need to identify and quantify the demand for specific content. It may be paid for content such as Movies or books, or may be other data such as short films or manuscripts or requests for specific services. The demand in various areas is difficult to assess, as the costs incurred for a comprehensive market study may be prohibitive.

Specifically, the demand for Entertainment Content has traditionally been analyzed after the content has been consumed using traditional methods (such as the Nielsen content ratings). This analysis is limited to usage data (data describing how, where, when, by who etc. the product/service was used) and therefore only good for evaluating usage data.

Currently, there are no methods for evaluating the impact that different business rules (rules enforcing restrictions on distribution, age, region, time etc) have on the demand for usage, aside from full scale marketing studies. In general, marketing studies are expensive and are not very reliable for finding out about completely unsuspected marketing areas.

### SUMMARY OF THE INVENTION

According to a first aspect of the present invention there is thus provided network interactive distribution auxiliary apparatus for association with content distribution over a network from content sources in accordance with user requests to content distribution sites, the content being held in content holding sites, the apparatus comprising:

a database for holding data of placement of content around the content holding sites,

a request receiver for receiving requests for content from the content distribution sites, and

a content distribution co-ordinator, associated with the database for using the placement data to direct the data holding sites to provide content to respective requesting consumers in accordance with the requests.

Preferably, the co-ordinator is operable to provide different content items from different data holding sites to fulfill a single request.

Preferably, distribution restrictions are associated with individual content items.

Preferably, the co-ordinator is operable to provide alternatives in the event that a request coincides with a restriction.

Preferably, the co-ordinator is operable to provide information concerning requests that coincide with restrictions.

The apparatus preferably comprises a payment unit for passing payment between content distribution parties according to a contribution to a finally packaged content product as sent to a consumer.

According to a second aspect of the present invention there is provided a network interactive distribution auxiliary apparatus for association with content distribution over a network from content sources in accordance with user requests to content distribution sites, the content being held in content holding sites, the apparatus comprising:

a database for holding data of placement of content around the content holding sites,

a request receiver for receiving requests for the placement data from the content distribution sites, and

a content distribution co-ordinator, associated with the database for sending the placement data to the distribution sites to enable the distribution sites to supply the content via the content holding sites.

Preferably, the co-ordinator is operable to provide the placement data of different content items at different data holding sites to fulfill a single request.

Preferably, distribution restrictions are associated with content and wherein the co-ordinator is operable to provide alternatives in the event that a request coincides with a restriction.

Preferably, the co-ordinator is operable to provide information to a content source concerning requests that coincide with restrictions.

The apparatus preferably comprises a payment unit for passing payment between content distribution parties according to a contribution to a finally packaged content product as sent to a consumer.

According to a third aspect of the present invention there is provided a network interactive distribution apparatus comprising:

a content distribution site for offering a range of content items to consumers and receiving requests from consumers for the content, and

a content holding site for holding content at a location on a network and sending the content to users in response to a request from the distribution site, wherein the content distribution site is able to access data indicating, for at least some of the range of content items, a corresponding holding site holding the content.

Preferably, at least one content item is held at a plurality of the content holding sites, the distribution site comprising functionality to select a one of the holding sites being most effectively located to provide the data to a given requesting consumer.

Preferably, the content holding site comprises functionality to determine that a given request requires handling by using content from a plurality of content holding sites and further comprises functionality to send requests to each of the plurality of content sites to fulfill the request.

Preferably, at least some of the content items are associated with distribution restrictions, the distribution site comprising functionality to query a distribution restriction and to offer an alternative content item that overcomes the distribution restriction.

According to a fourth aspect of the present invention there is provided a method of providing content distribution over a network from content sources in accordance with user requests to content distribution sites, the content being held in content holding sites, the method comprising:

holding data of placement of content around the content holding sites,

receiving requests for the placement data from the content distribution sites, and

sending the placement data to the distribution sites to enable the distribution sites to supply the content via the content holding sites.

According to a fifth aspect of the present invention there is provided a method of providing content distribution over a network from content sources in accordance with user requests to content distribution sites, the content being held in content holding sites, the method comprising:

holding data of placement of content around the content holding sites,

receiving requests for content from the content distribution sites, and

using the placement data to direct the data holding sites to provide content to respective requesting consumers in accordance with the requests.

According to a sixth aspect of the present invention there is provided a network interactive distribution auxiliary apparatus for association with content distribution over a network from content sources in accordance with user requests, the apparatus comprising:

a request gathering unit for obtaining data of user requests over a network for respective content items, the data comprising at least details of request fulfillment failures, and

a request failure analysis unit associated with the request fulfillment unit for using output of the request gathering unit to analyze the request fulfillment failures.

The apparatus preferably comprises a content directing unit associated with the request failure analysis unit, for directing and packaging content from at least one content source, the request failure unit further being operable to use the analysis in controlling the content directing unit to overcome the failure.

Preferably, the overcoming comprises a repackaging involving respective requested content.

Additionally or alternatively, the repackaging comprises editing of the respective requested content.

Additionally or alternatively, the repackaging comprises mixing at least some of the respective requested content with other content.

Preferably, the apparatus is associated with a plurality of content sources.

Preferably, the repackaging comprising packaging with advertising.

Preferably, the content is held at distributed locations on the network, the request failure analysis unit being operable to interact with the distributed locations to direct repackaged content to the users.

The apparatus preferably comprises a payment receipt unit for receiving payment for the repackaged content and a payment distribution unit for distributing at least some of the payment to respective sources of the repackaged content.

Preferably, the repackaging comprises adding advertising content, the payment distribution unit being operable to direct payment from an advertising source to a respective content source.

Preferably, the payment distribution unit is operable to distribute payment from the advertising source amongst a plurality of respective content sources.

Preferably, the request failure analysis unit comprises a report compiler for compiling the analysis into reports for respective content sources.

Preferably, the report compiler is operable to exclude from the reports data identifying individual consumers.

Preferably, the request failure analysis unit is operable to use data in the analysis regarding at least one of a group comprising: geographical factors, temporal market data, pricing factors, personal data of a requesting party, network infrastructure operability in the vicinity of a requesting party, and content provider distribution factors.

Preferably, the personal data of a requesting party comprises at least one of legal restrictions on the party, age related restrictions on the party, contractual restriction, risk based restrictions and content provider restrictions on the party.

According to a seventh aspect of the present invention there is provided a network content interactive packaging apparatus for suiting content to consumers, the apparatus comprising:

access to at least one content provider providing content for distribution,

access to at least one distribution node,

an input for receiving data of user requests for content including data about whether the requests have been fulfilled,

a processor, associated with the input, for analyzing failures to fulfill the requests and to use the analysis to repackage the content to minimize the failures to fulfill, or to obtain pre-repackaged content.

Preferably, the processor comprises a repackager for repackaging the content, the repackager being associated with the access to the at least one distribution node, thereby being operable to repackage by instructing the distribution node in selection of content for sending to fulfill a user request.

Preferably, the repackaging is provided on a per content provider basis.

Preferably, the repackaging is provided on a per request basis.

Preferably, the repackaging comprises editing of the content.

Preferably, the repackaging comprises addition of other content to respective requested content.

Preferably, the repackaging comprises addition of advertising material.

Preferably, the processor further comprises a report generator for providing reports of the analysis.

Preferably, the per content report generator is operable to exclude from the reports data identifying individual consumers.

The apparatus preferably comprises a payment receipt unit for receiving payment for the repackaged content and a payment distribution unit for distributing at least some of the payment to respective sources of the repackaged content.

Preferably, the repackaging includes advertising content, the payment distribution unit being operable to direct payment from an advertising source to a respective content source.

Preferably, the payment distribution unit is operable to distribute payment from the advertising source amongst a plurality of respective content sources.

Preferably, the processor is operable to use, in the analysis, data regarding at least one of a group comprising: geographical factors, temporal market data, pricing factors, personal data of a requesting party, network infrastructure operability in the vicinity of a requesting party, and content provider distribution factors.

Preferably, the personal data of a requesting party comprises at least one of legal restrictions on the party, age related restrictions on the party, contractual restrictions, risk based restrictions, and content provider restrictions on the party. According to an eighth aspect of the present invention there is provided a network content distribution support method for supporting the distribution of electronic content, products or services via distribution sites over a network, the method comprising:

obtaining, via the network, from the distribution sites, information of requests for the content, products or services, including data of non-completed requests,

analyzing on line the data of non-completed requests to determine why an individual request was not completed,

offering to a requesting party an alternative to the request which overcomes a reason for non-completion determined in the analysis, and

directing, over the network, packaging and routing to the consumer of the alternative.

The method preferably comprises providing different items of content, product or service from different data holding sites to fulfill a single request.

Preferably, distribution restrictions are associated with individual items

The method preferably comprises providing alternatives in the event that a request coincides with a distribution restriction.

The method preferably comprises providing information concerning requests that coincide with restrictions

The method preferably comprises passing payment between content distribution parties according to a contribution to a finally packaged content product as sent to a consumer.

The method preferably comprises using the analysis for any one of a group of uses comprises altering distribution channels, modifying a distribution policy, and modifying distribution rules.

The method preferably comprises at least one of correlating, gathering and weighting the details with additional information.

Preferably, the additional information comprises any one of. information about content that was actually sold, information about content that was sought, and information of content that was distributed in other ways.

The method preferably comprises using the analysis to evaluate existing market segmentation criteria The method preferably comprises using the analysis to focus marketing efforts on potential market segments.

The method preferably comprises directing the analysis to unauthorized content distribution.

According to a ninth aspect of the present invention there is provided a network content distribution support method for supporting the distribution of electronic content, products or services via distribution sites over a network, the method comprising:

obtaining, from the distribution sites, information of requests for the content, products or services, including data of non-completed requests,

statistically analyzing the data of non-completed requests taken together to determine why requests are not being completed, and

providing the, results of the statistical analysis.

The method preferably comprises providing different items of content, product or service from different data holding sites to fulfill a single request.

Preferably, distribution restrictions are associated with individual items

The method preferably comprises providing alternatives in the event that a request coincides with a distribution restriction.

The method preferably comprises providing information concerning requests that coincide with restrictions

The method preferably comprises passing payment between content distribution parties according to a contribution to a finally packaged content product as sent to a consumer.

The method preferably comprises using the analysis for any one of a group of uses comprises altering distribution channels, modifying a distribution policy, and modifying distribution rules.

The method preferably comprises at least one of correlating, gathering and weighting the details with additional information.

Preferably, the additional information comprises any one of. information about content that was actually sold, information about content that was sought, and information of content that was distributed in other ways.

The method preferably comprises using the analysis to evaluate existing market segmentation criteria The method preferably comprises using the analysis to focus marketing efforts on potential market segments.

The method preferably comprises directing the analysis to unauthorized content distribution.

According to a tenth aspect of the present invention there is provided a network content distribution support method for supporting the distribution of electronic content, products or services via distribution sites over a network, the method comprising:

obtaining, via the network, from the distribution sites, information of requests for the content, products or services, including data of non-completed requests,

analyzing on line the data of non-completed requests to determine why an individual request was not completed,

offering to a requesting party an alternative to the request which overcomes a reason for non-completion determined in the analysis,

directing, over the network, the packaging and directing to the consumer of the alternative,

statistically analyzing the data of non-completed requests taken together to determine why requests are not being completed,

providing, over the network, to content providers, results of the statistical analysis.

The method preferably comprises providing different items of content, product or service from different data holding sites to fulfill a single request.

Preferably, distribution restrictions are associated with individual items

The method preferably comprises providing alternatives in the event that a request coincides with a distribution restriction.

The method preferably comprises providing information concerning requests that coincide with restrictions

The method preferably comprises passing payment between content distribution parties according to a contribution to a finally packaged content product as sent to a consumer.

The method preferably comprises using the analysis for any one of a group of uses comprises altering distribution channels, modifying a distribution policy, and modifying distribution rules.

The method preferably comprises at least one of correlating, gathering and weighting the details with additional information.

Preferably, the additional information comprises any one of. information about content that was actually sold, information about content that was sought, and information of content that was distributed in other ways.

The method preferably comprises using the analysis to evaluate existing market segmentation criteria The method preferably comprises using the analysis to focus marketing efforts on potential market segments.

The method preferably comprises directing the analysis to unauthorized content distribution.

According to an eleventh aspect of the present invention there is provided a data carrier operable with a general purpose computer to provide a network content distribution support method for supporting the distribution of electronic content, products or services via distribution sites over a network, the method comprising:

obtaining, via the network, from the distribution sites, information of requests for the content, products or services, including data of non-completed requests,

analyzing on line the data of non-completed requests to determine why an individual request was not completed,

offering to a requesting party an alternative to the request which overcomes a reason for non-completion determined in the analysis,

directing, over the network, the packaging and directing to the consumer of the alternative,

statistically analyzing the data of non-completed requests taken together to determine why requests are not being completed, and

providing, over the network, to content providers, results of the statistical analysis.

According to a twelfth aspect of the present invention there is provided an interface within a networked distribution arrangement, the arrangement comprising a plurality of nodes including at least two of a content source node, a monitoring node, a content distribution node and a content holding node, the interface linking at least some of the nodes and comprising consumer related details, thereby to allow distribution restriction control from each of the nodes linked by the interface.

The interface preferably comprises a transfer mechanism operable to transfer consumer and content related details.

The interface preferably comprises a transfer mechanism operable to transfer specific consumer related details

The interface preferably comprises a transfer mechanism operable to transfer the specific consumer group related details.

The interface preferably comprises a transfer mechanism operable to transfer the specific consumer groups specifications.

Preferably, the transfer is performed in response to a plurality of queries about subsets of the details.

Preferably, the queries are performed reactively as responses to queries not relating to the details.

The interface preferably comprises an identification detection mechanism for detecting details that identify a consumer and suppressing the details from data to be transferred thereby to ensure that a node receiving the transfer is not provided with consumer identifying details.

The interface preferably comprises a transaction identification mechanism the operable to identify a transaction without identifying a requesting consumer.

Preferably, the identification mechanism is operable to utilise a temporary ID.

Preferably, the temporary ID comprises a transaction ID.

Preferably, temporary ID comprises a session. Preferably, the information includes consumer specific content price.

Preferably, the details comprise consumer related restrictions.

Preferably, the details comprise consumer specific content restrictions.

Preferably, the details comprise consumer specific content usage preferences.

Preferably, the details comprise consumer specific available content information.

Preferably, the details comprise consumer specific authorized content information.

Preferably, the details comprise consumer service information.

### BRIEF DESCRIPTION OF THE DRAWINGS

For a better understanding of the invention and to show how the same may be carried into effect, reference will now be made, purely by way of example, to the accompanying drawings.

With specific reference now to the drawings in detail, it is stressed that the particulars shown are by way of example and for purposes of illustrative discussion of the preferred embodiments of the present invention only, and are presented in the cause of providing what is believed to be the most useful and readily understood description of the principles and conceptual aspects of the invention. In this regard, no attempt is made to show structural details of the invention in more detail than is necessary for a fundamental understanding of the invention, the description taken with the drawings making apparent to those skilled in the art how the several forms of the invention may be embodied in practice. In the accompanying drawings:

FIG. 1 is a simplified schematic diagram showing entities involved in conventional distribution of electronic content over a network,

FIG. 2 is a simplified schematic diagram showing the entities involved in the distribution of electronic content over a network in accordance with an embodiment of the present invention,

FIG. 3 is a simplified schematic diagram showing content distribution and holding sites for supplying content to consumers,

FIG. 4 is a simplified diagram of a first embodiment of a server for supporting content distribution according to a first embodiment of the present invention,

FIG. 5 is a simplified diagram of a second embodiment of a server for supporting content distribution according to a second embodiment of the present invention,

FIG. 6 is a simplified diagram of a server operative in accordance with an embodiment of the present invention, and

FIG. 7 is a simplified flow chart showing the operation of a preferred embodiment of the present invention.

### DESCRIPTION OF THE PREFERRED EMBODIMENTS

The present embodiments provide an apparatus and method for real time distribution of online content, including the management of preliminary distribution of the content around the network at sites that are convenient for passing on to consumers whereas the content distribution sites which advertise and sell the material are otherwise distributed. The consumer is thus provided with the desired content irrespective of the consumer's location and of the location of the site selling the content. The consumer may additionally be provided with material from a number of locations in fulfillment of a single request. The system further provides the ability to study online requests for content or for products and services in general, in particular for online requests that do not result in a sale, for the purpose of providing content providers with information about potential new markets that are currently being excluded and also to provide consumers with acceptable alternatives. In a preferred embodiment, refused or otherwise not completed requests are analyzed in real time so that the specific consumer may be offered an acceptable alternative.

Before explaining at least one embodiment of the invention in detail, it is to be understood that the invention is not limited in its application to the details of construction and the arrangement of the components set forth in the following description or illustrated in the drawings. The invention is applicable to other embodiments or of being practiced or carried out in various ways. Also, it is to be understood that the phraseology and terminology employed herein is for the purpose of description and should not be regarded as limiting.

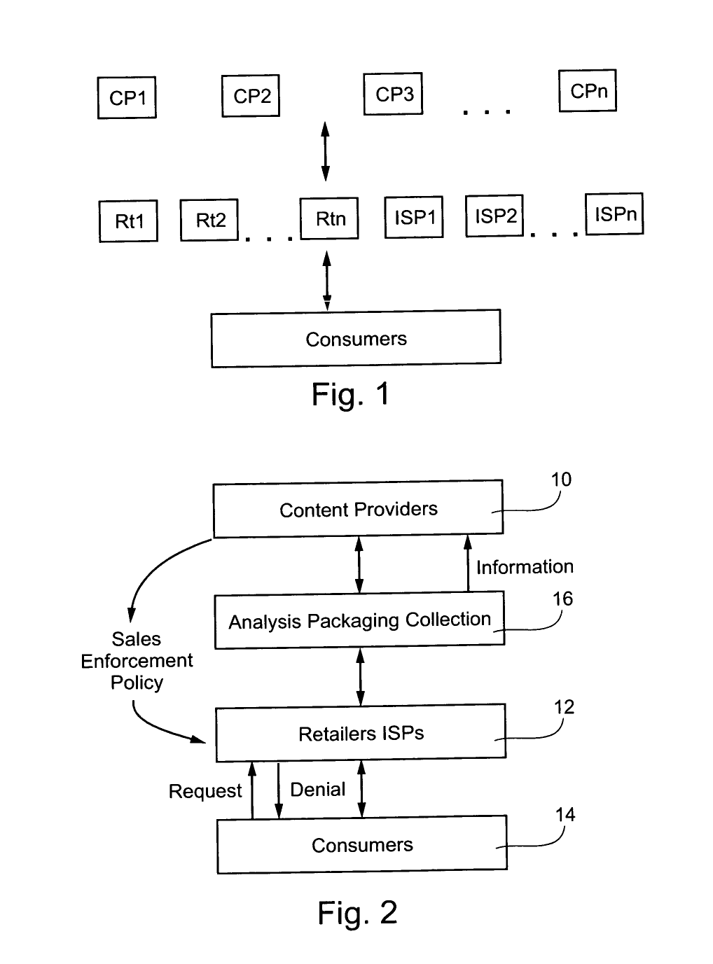

Reference is now made to FIG. 1, which is a simplified schematic diagram showing how content distribution is carried out currently on the Internet. Currently a series of content providers CP1 . . . CPn each independently provide content. The content is made available to consumers via the Internet through content retailers RT1 . . . RTn or directly through internet service providers ISP1 . . . ISPn. Generally, the retailers also reach the consumers through Internet service providers. Each content provider generally works independently to follow market trends, respond to requests for content, set prices and choose when to refuse requests. Generally, retailers likewise carry out such tasks for their own purposes. Sharing of information between different retailers and between different content providers and between retailers and content providers is not generally practiced, partly due to competition concerns and partly due to privacy concerns. Furthermore some of the retailers may be inconveniently located to provide content to certain consumers.

Reference is now made to FIG. 2, which is a simplified schematic diagram showing content distribution operative in accordance with a preferred embodiment of the present invention. In the embodiment of FIG. 2, the content providers 10, the retailers and Internet service providers 12, and the consumers 14 are each treated as unified layers, and an additional layer, herein marked as analysis, packaging and collection 16, is provided between the content providers and the retailers and ISP layer. As will be explained in more detail below, the analysis, packaging and collection layer serves to unify content distribution by linking requests with content at content holding sites and independently analyzing content requests. Linking between requests to retailers and content at content location sites allows for efficient delivery of content to the user regardless of the retailer being used. In addition or as an alternative, the layer 16 analyses requests that have been made but not fulfilled to determine why the requests were not fulfilled. The layer may then report to the respective content provider on the fact of non-delivery of the content, or it may retain data of the refusal for subsequent building of a statistical picture of non-fulfilled transactions, or it may attempt to repackage the content, as will be explained in more detail below, in order to overcome the reason for non-fulfillment of the request. The aim of repackaging is to provide content that the user wants and that overcomes the reason for non-fulfillment of the request. To take a simple example, a user may request a particular movie and then discover the price to be too high. The layer is able to repackage the movie with additional advertising content, thereby to reduce the price to the consumer. Alternatively, the layer may provide less costly lower resolution or edited versions of the movie.

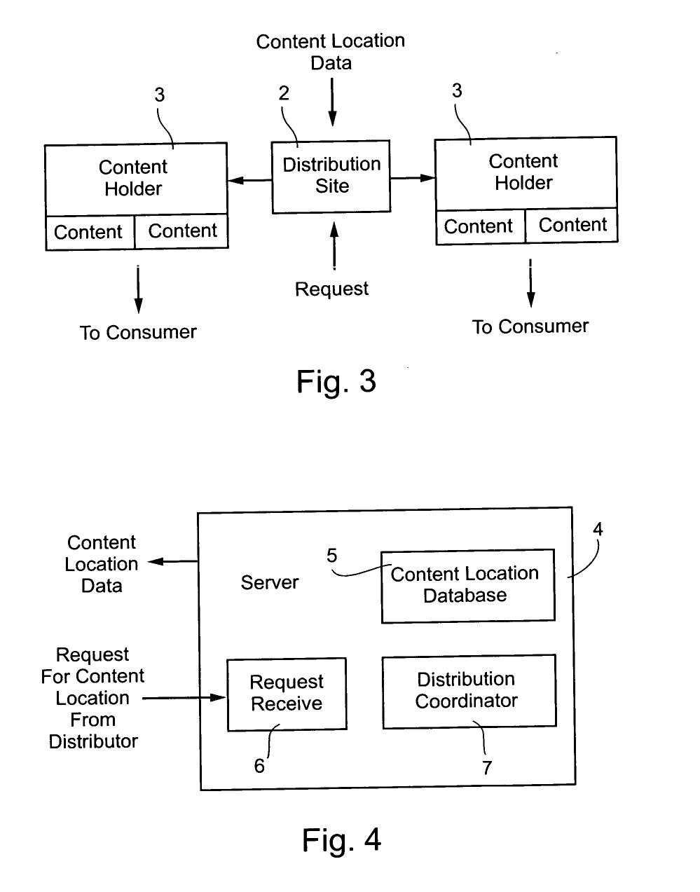

Reference is now made to FIG. 3, which is a simplified schematic diagram showing a network interactive distribution apparatus. The apparatus comprises a content distribution site 2 for offering a range of content items to consumers and receiving requests from consumers for the content, essentially a typical website for browsing and through which consumers are able to order content. However, the content itself is not held at the site and a content holding site 3 actually stores the content, at a location on a network, and sends the content to users in response to a request from the distribution site 2. The content distribution site 2 is preferably able to access data indicating a corresponding holding site 3 holding the requested content. Preferably the holding sites are located at appropriate locations on the network that enable easy distribution to consumers.

In one embodiment of the present invention at least one content item is held at a plurality of such content holding sites. In such a case, the distribution site 2 preferably comprises functionality to select a holding sites being most effectively located to provide the content to a given requesting consumer.

Preferably, the content holding site comprises functionality to determine that a given request requires content from a plurality of content holding sites and further comprises functionality to send requests to each of the relevant content sites to fulfill the request.

In many cases, some of the content items are associated with distribution restrictions. In such a case, the distribution site may comprise functionality to query a distribution restriction and to offer an alternative content item that overcomes the distribution restriction.

Reference is now made to FIG. 4, which is a simplified block diagram showing a server according to an embodiment of the present invention. The server comprises a network interactive distribution auxilliary apparatus for use in content distribution over a network from content sources in accordance with user requests to content distribution sites as described above. Again as described above, the content is held in content holding sites.

The server 4 comprises a database 5 for holding data of placement of content around the various content holding sites 3. In addition there is provided a request receiver 6 for receiving requests for the placement data in the database. The requests are received from the content distribution sites. In addition there is provided a content distribution co-ordinator 7, associated with the database for sending the placement data to the distribution sites to enable the distribution sites to supply content via the content holding sites.

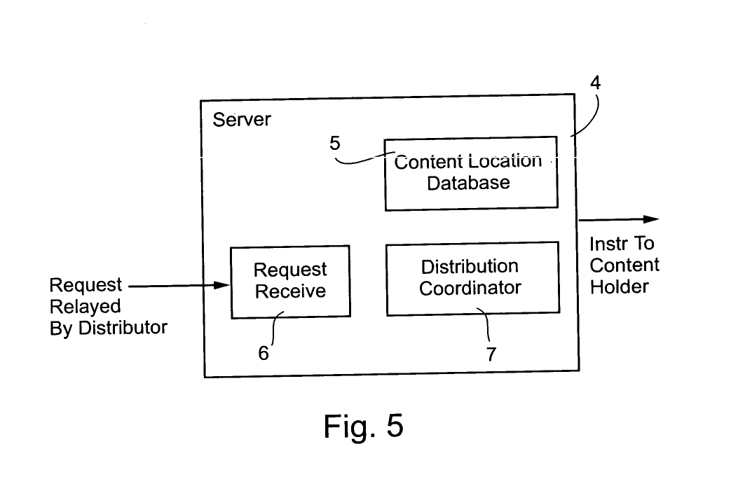

Reference is now made to FIG. 5, which is a simplified diagram showing an alternative embodiment of the server of FIG. 4. Parts that are the same as those in previous figures are given the same reference numerals and are not described again except as necessary for an understanding of the present embodiment. In FIG. 5, the server actually receives details of the requests from the distribution site and the co-ordinator 6 interrogates the database 5 and sends its own request to the content holding sites to supply the data.

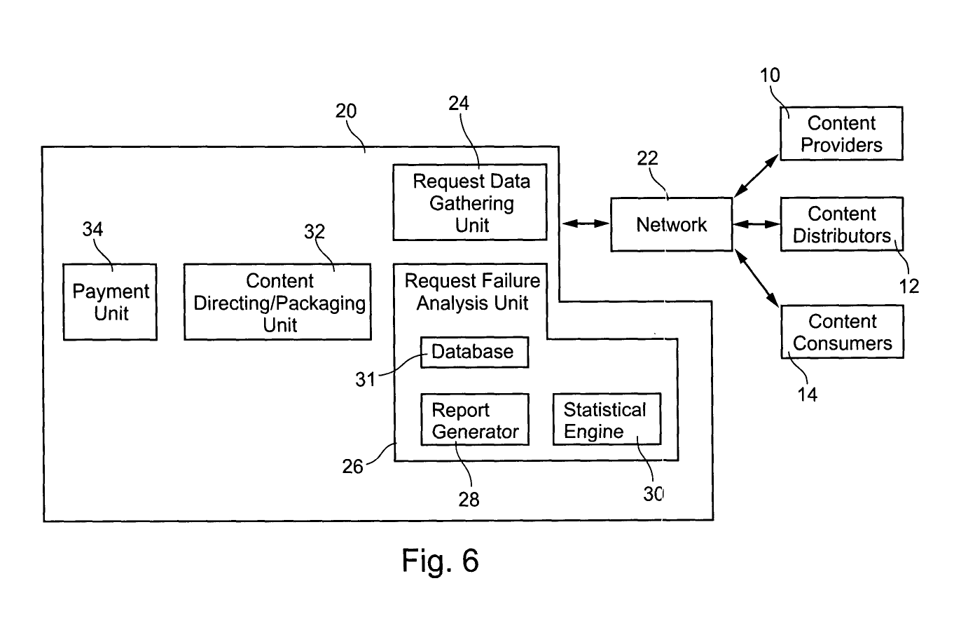

Reference is now made to FIG. 6, which is a simplified block diagram showing network interactive distribution auxilliary apparatus 20 for association with content distribution over a network 22. The content is initially provided by content sources or providers 10, and is made available at distributors 12 from where it is provided to consumers 14 in accordance with requests therefrom. Parts or features that appear in earlier figures are given the same reference numerals and are not discussed in detail again except as needed for an understanding of the present embodiment. The apparatus 20 is preferably server based.

The apparatus 20 preferably comprises a request data gathering unit 24 for obtaining data of user requests for respective content items that are available over network 22. Preferably the data comprises at least details of request fulfillment failures.

Apparatus 20 further comprises a request failure analysis unit 26, which is associated with the request data gathering unit 24. The request failure analysis unit preferably uses output of the request gathering unit to analyze request fulfillment failures, which is to say that it is intended to determine the reasons behind request fulfillment failures. Analysis results may be made available for individual requests, and if such results can be made in real time then the apparatus may be used to offer the consumer an alternative content package which overcomes the apparent reason for refusal, as will be explained in more detail below. Additionally, analysis results may be made available on a global basis and may be provided in the form of reports to individual content providers. For the purpose of producing such reports, the analysis unit 26 is preferably provided with a report generator 28 which may arrange statistical information regarding individual content or different content items from a given content source. Preferably the reports so generated provide the statistical information in such a way as not to interfere with the privacy of individual consumers. A statistical engine 30 preferably provides statistical tools necessary to carry out the analysis.

The refusal analysis unit preferably includes a database 31. The database preferably includes at least data of refusals being considered. In addition it may include profiles of individual consumers or groups of consumers and additional data which can be used together with the profiles or with the refusal information. The kind of data that may be taken into account in the analysis typically includes geographical factors, temporal market data, pricing factors, personal data of the individual consumers, personal data of a statistically constructed group of consumers to whom the individual consumer is believed to belong, the state of network infrastructure operability in the vicinity of a requesting party, and content provider distribution factors.

The kind of personal data of a consumer that may be considered includes legal restrictions on the consumer, age related restrictions on the consumer, and content provider restrictions on the consumer. For example the particular consumer may be blacklisted by a given content provider due to past misdemeanors.

As discussed above, the system analyses data gathered by a content distribution system. The content distribution system acts according to enforcing rules defined by the content providers to control the distribution.

On the content provider level, analyzing user profiles of users who are refused content may reveal user groups who are interested in accessing the content but are refused due to usage rules. Such information thus provides content providers with the option to change the rules, or modify the product or service in order to enable the newly identified consumers or groups thereof to obtain the product or service, thus potentially enhancing their revenue streams.

As mentioned above, preferred embodiments are able to react to individual request refusals. Such a reaction is achieved using content directing/packaging unit 32. Unit 32 receives request failure analysis information and uses the information to offer to the consumer an alternative which overcomes the reason for refusal. In the preferred embodiment, the content directing and packaging unit 32 does not in fact handle content as such. It simply knows where content is located around the Internet and is able to instruct such locations to supply content to consumers in accordance with its directions. It is therefore able to supply consumers with packages of content even when different parts of that content are available only at different locations and from different providers.

Examples of types of refusals that may be encountered and possible alternatives that can be provided are given in the following examples:

### EXAMPLE 1

A consumer of unverified age requests a movie suitable only for persons aged 18 and over. The content directing/packaging unit therefore offers an edited version of the movie which is suitable for all ages. Alternatively, the request is simply refused in the normal way, but data of the refusal is stored and the content provider is given the information that numbers of under-age consumers have requested the content. The content provider is thus able to edit the content and offer it in a form suitable for the given age group.

### EXAMPLE 2

An Italian sneaking consumer requests a movie from an American based company, only to discover that the movie is in English without subtitles. The consumer therefore declines to complete the transaction. The content directing/packaging unit 32 notes the consumer's location in Italy, and offers a version from an Italian content provider with Italian subtitles. Preferably, it is ensured that both the American and Italian content providers are credited for the sale.

### EXAMPLE 3

A consumer, who has a history of requesting movies at a given price, makes a request for a movie at a higher price, but then does not complete the transaction. The content directing/packaging unit 32 notes the price difference and assumes that to be the reason for the refusal. It therefore repackages the movie with commercial advertising and offers it at a lower price. Alternatively or additionally, the content provider is provided with statistical information indicating that the content was refused by requesters who had shown a willingness to purchase at a given lower price.

### EXAMPLE 4

A consumer requests content via streaming video. The connection between the requester and the content provider is however too slow to allow for the connection to proceed. The streaming video is therefore terminated. The content directing/packaging unit may be able to find a provider of the same content at a closer location. Alternatively the providers of intervening infrastructure may be made aware of the existence of bottlenecks in the network.

A payment unit 34 is provided to ensure that the correct content providers are credited when a sale is made. The payment unit keeps track of where content has been taken from and what advertising if any has been added and ensures that payments flow from the consumers and advertisers to the content providers.

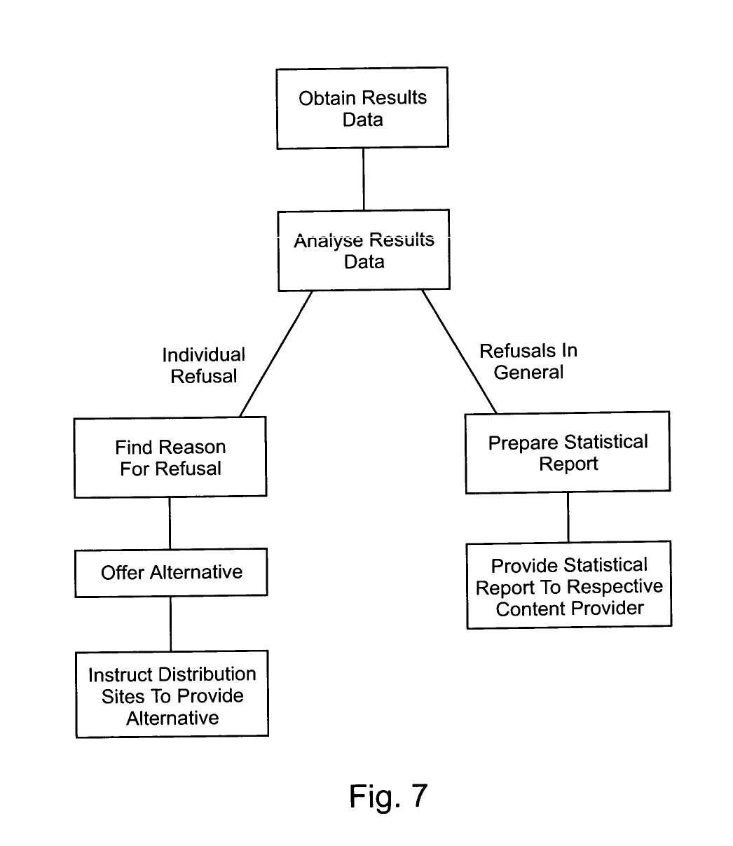

Reference is now made to FIG. 7, which is a simplified flow chart showing operation of a network content distribution support method for supporting the distribution of electronic content, products or services via distribution sites over a network, operative in accordance with a preferred embodiment of the present invention. The method comprises obtaining, via the network, from the distribution sites, information of requests made by consumers, for content, products or services, including data of non-completed requests. The data is analyzed on line to determine why an individual request was not completed. Individual requests may be analyzed in the light of other requests and in the light of a personal profile of an individual consumer if available, or of a profile of a group to which the consumer is deemed to belong or to other information that may be available.

The analysis preferably makes available one or more most likely reasons for refusal and then it is possible to offer to the consumer an alternative to the requested content etc. which overcomes the apparent reason for non-completion. It will be appreciated that if there is more than one likely reason for non-completion then the consumer may be provided with alternatives corresponding to each of the reasons.

The method further comprises directing, over the network, the packaging and directing to the consumer of any alternative that the consumer may choose to accept. The method does not envisage the holding of content but rather the coordinating between different distribution sites and content providers so that the consumer may be provided seamlessly with appropriate content without his being aware that, in some cases, material from different distributors and/or providers is being mixed and matched. In another alternative embodiment, the method involves the holding of content from one or more content providers, which may be mixed and matched to be provided to the consumer.

In addition, on a global basis, the method carries out a statistical analysis of data of non-completed requests taken together to determine why requests are not being completed. The data is then provided into reports, either on a per content item basis, or on a content provider basis, or on a per distributor basis and is provided over the network to the party requesting the report.

In a further preferred embodiment, data may be gathered regarding illegal content distribution. Illegal distribution represents lost sales in the same way as request refusals and a thorough understanding of the illegal distribution situation for particular content items may lead to increased sales opportunities.

It is stressed that in the above embodiments, the denial of service is not a concept that is restricted to a refusal to provide content by the content provider, but may also include a transaction begun and not completed, either by the consumer himself or for any other reason and also, in so far as it is possible to obtain relevant data, where a consumer simply looks at a content item but then chooses not to buy it.

For example, the consumer may be interested in a content item, but then stops browsing. He may, had he continued, have made a purchase attempt but for some reason he stopped. Possible reasons include his observation that the request would have been refused because of his age or because of his geographical location. Likewise he may have stopped because of unacceptable consequences such as high price, revealing of personal information, security restrictions, functional restrictions etc. or simply because he did not have a credit card.

The purchase experience may, in certain cases be personalized, meaning that the purchaser identifies himself in some way, perhaps by means of a cookie or perhaps by logging in. The purchase experience may include denial or pseudo-denial situations, for example due to background monitoring for suspicious situations, and the entity that controls the denial situation may not be aware of the restrictions set on the consumer and/or the identity and the details of thethe consumer, for example because of privacy concerns. For example the distributor entity may be in control of denying the purchase but may not be aware that the purchase falls into a pattern of suspected fraud that is currently being investigated by the content provider, or a pattern of money laundering being investigated by the authorities. In this case, an interface may be provided between one or more of the entities who possess such information, or part or derivative thereof, (e.g. the content provider, or the law enforcement authorities) and one or more of the entities that provide the purchase experience. Such an interface may be needed in order to provide the personalized browsing experience and to make use of the information gathered by the afore-mentioned means. This could include enabling one or more of the involved parties to make use of thethe information, possibly by including thethe information (or part or derivative thereof) in thethe interface. Such an interface may comprise communicating the consumer details, profile, part, or derivative thereof, or providing a list (or part of a list) of content available for purchase for the relevant consumer. TheThe list may include pricing and/or restrictions information. In another embodiment, such information may be provided in response to queries (for example: “at what price and restrictions if at all a user of profile X can acquire content Y?”). Preferably, the details may be provided without revealing the explicit identity of the consumer, as mentioned above.

In order to provide the above there is provided an interface within a networked distribution arrangement of the kind described above oncluding a content source node, a monitoring node, a content distribution node and a content holding node. Preferably, the interface links at least some of the nodes and comprises consumer related details. The interface thus provides a unified platform that allows contributions to distribution restriction control from each of the nodes that it links.

Preferably, the interface comprises a transfer mechanism operable to transfer consumer and content related details, including specific consumer related details, specific consumer group related details, specific consumer groups specifications, consumer preferences, consumer specific content price, consumer related restrictions, consumer specific content restrictions, consumer specific content usage preferences, consumer specific available content information, consumer specific authorized content information, and consumer service information.

The transfer may be performed in response to a plurality of queries about subsets of any of the above-mentioned details. Alternatively, the transfer may be performed as a reaction to queries requesting different details.

The interface may use an identification detection mechanism for detecting details that identify a consumer and suppressing such identifying details from data to be transferred, thereby to ensure that a node receiving the transfer is not provided with consumer identifying details. Thus the interface is able to protect consumer confidentiality and its use does not give rise to privacy concerns.

In place of consumer identification the interface may make use of a transaction identification mechanism to identify an action or request or transaction, without at the same time identifying a requesting consumer.

The identification mechanism may use a temporary ID for such purposes, which may be a transaction ID or a session ID.

In situations where the purchasing process is personalized, for example where the site requires logging in, the actions of the consumer may be monitored to show what content he is looking for. Thus, if the site is arranged not to show a title of a restricted item to those who are not allowed to receive it, the monitoring system according to the above-described embodiments can nevertheless try to discern if the consumer is trying to locate it, especially if a textual or other search facility exists.

In certain cases, attempts to discern what a consumer is looking for can be statistical in nature, and may thus be attached to a confidence level. Such attempts are thus particularly suitable for AI and neural network based processing.

A benefit of the analysis of the denied requests comes from an ability to reveal an otherwise hidden demand for products and/or services in segments that a company is not selling to or serving at a given time, or may reveal a hidden demand or preferences for products and/or services that a company can supply, provided that a change is made to the product as currently on offer. The change in the products/services that the company supplies may be in the product features themselves or alternatively in the way that they are sold, that is, in the company's policy and business rules regarding the products' and/or services' distribution or in the overall packaging. For this purpose the Company's or market's business rules may include, but not be limited to price, promotions, payment methods and intervals, currencies, geographical regions, type of resellers and their characteristics, type of buyers and their characteristics, and more.

The denied requests may be gathered online, over the Internet, over mail, over telephone or in any other way. The denied requests may be for online purchase, for purchases of video files/streams over the Internet, or for any other product and/or service.

As explained above, the query and analysis of the denied requests may be in real time, may be used to build different products and/or services, to alter distribution channels, to modify company policy and/or business rules in general, to modify company policy and/or business rules regarding distribution of products and/or services, or for any other purpose.

The gathered information may be correlated and/or aggregated and/or weighted with information gathered through other means, e.g. information about content that was actually sold, and content that was sought after and/or distributed on other (possibly illegitimate) distribution channels, as explained above.

The gathered information may also be used in order to evaluate the existing market segmentation criteria and to focus marketing efforts on potential market segments (both for the relevant content and for similar content items).

It is appreciated that certain features of the invention, which are, for clarity, described in the context of separate embodiments, may also be provided in combination in a single embodiment. Conversely, various features of the invention which are, for brevity, described in the context of a single embodiment, may also be provided separately or in any suitable subcombination.

It will be appreciated by persons skilled in the art that the present invention is not limited to what has been particularly shown and described hereinabove. Rather the scope of the present invention is defined by the appended claims and includes both combinations and subcombinations of the various features described hereinabove as well as variations and modifications thereof which would occur to persons skilled in the art upon reading the foregoing description.

1. Network interactive distribution auxiliary apparatus for association with content distribution over a network from content sources in accordance with user requests to content distribution sites, said content being held in content holding sites, said apparatus comprising:
a database for holding data of placement of content around said content holding sites,
a request receiver for receiving requests for content from said content distribution sites, and
a content distribution co-ordinator, associated with said database for using said placement data to direct said data holding sites to provide content to respective requesting consumers in accordance with said requests.

2. The apparatus of claim 1, wherein said co-ordinator is operable to provide different content items from different data holding sites to fulfill a single request.

3. The apparatus of claim 1, wherein distribution restrictions are associated with individual content items.

4. The apparatus of claim 3, wherein said co-ordinator is operable to provide alternatives in the event that a request coincides with a restriction.

5. The apparatus of claim 1, wherein said co-ordinator is operable to provide information concerning requests that coincide with restrictions.

6. The apparatus of claim 1, further comprising a payment unit for passing payment between content distribution parties according to a contribution to a finally packaged content product as sent to a consumer.

7. Network interactive distribution auxiliary apparatus for association with content distribution over a network from content sources in accordance with user requests to content distribution sites, said content being held in content holding sites, said apparatus comprising:
a database for holding data of placement of content around said content holding sites,
a request receiver for receiving requests for said placement data from said content distribution sites, and
a content distribution co-ordinator, associated with said database for sending said placement data to said distribution sites to enable said distribution sites to supply said content via said content holding sites.

8. The apparatus of claim 7, wherein said co-ordinator is operable to provide said placement data of different content items at different data holding sites to fulfill a single request.

9. The apparatus of claim 7, wherein distribution restrictions are associated with content and wherein said co-ordinator is operable to provide alternatives in the event that a request coincides with a restriction.

10. The apparatus of claim 7, wherein said co-ordinator is operable to provide information to a content source concerning requests that coincide with restrictions.

11. The apparatus of claim 7, further comprising a payment unit for passing payment between content distribution parties according to a contribution to a finally packaged content product as sent to a consumer.

12. Network interactive distribution apparatus comprising:
a content distribution site for offering a range of content items to consumers and receiving requests from consumers for said content, and
a content holding site for holding content at a location on a network and sending said content to users in response to a request from said distribution site, wherein said content distribution site is able to access data indicating, for at least some of said range of content items, a corresponding holding site holding said content.

13. The apparatus of claim 12, wherein at least one content item is held at a plurality of said content holding sites, said distribution site comprising functionality to select a one of said holding sites being most effectively located to provide said data to a given requesting consumer.

14. The apparatus of claim 12, wherein said content holding site comprises functionality to determine that a given request requires handling by using content from a plurality of content holding sites and further comprises functionality to send requests to each of said plurality of content sites to fulfill said request.

15. The apparatus of claim 12, wherein at least some of said content items are associated with distribution restrictions, said distribution site comprising functionality to query a distribution restriction and to offer an alternative content item that overcomes said distribution restriction.

16. A method of providing content distribution over a network from content sources in accordance with user requests to content distribution sites, said content being held in content holding sites, said method comprising:
holding data of placement of content around said content holding sites,
receiving requests for said placement data from said content distribution sites, and
sending said placement data to said distribution sites to enable said distribution sites to supply said content via said content holding sites.

17. A method of providing content distribution over a network from content sources in accordance with user requests to content distribution sites, said content being held in content holding sites, said method comprising:
holding data of placement of content around said content holding sites,
receiving requests for content from said content distribution sites, and
using said placement data to direct said data holding sites to provide content to respective requesting consumers in accordance with said requests.

18. Network interactive distribution auxiliary apparatus for association with content distribution over a network from content sources in accordance with user requests, the apparatus comprising:
a request gathering unit for obtaining data of user requests over a network for respective content items, said data comprising at least details of request fulfillment failures, and
a request failure analysis unit associated with said request fulfillment unit for using output of said request gathering unit to analyze said request fulfillment failures.

19. The apparatus of claim 18, further comprising a content directing unit associated with said request failure analysis unit, for directing and packaging content from at least one content source, said request failure unit further being operable to use said analysis in controlling said content directing unit to overcome said failure.

20. The apparatus of claim 19, wherein said overcoming comprises a repackaging involving respective requested content.

21. The apparatus of claim 20, wherein said repackaging comprises editing of said respective requested content.

22. The apparatus of claim 20, wherein said repackaging comprises mixing at least some of said respective requested content with other content.

23. The apparatus of claim 18, being associated with a plurality of content sources.

24. The apparatus of claim 20, wherein said repackaging comprising packaging with advertising.

25. The apparatus of claim 19, wherein said content is held at distributed locations on said network, said request failure analysis unit being operable to interact with said distributed locations to direct repackaged content to said users.

26. The apparatus of claim 25, further comprising a payment receipt unit for receiving payment for said repackaged content and a payment distribution unit for distributing at least some of said payment to respective sources of said repackaged content.

27. The apparatus of claim 26, wherein said repackaging comprises adding advertising content, said payment distribution unit being operable to direct payment from an advertising source to a respective content source.

28. The apparatus of claim 27, wherein said payment distribution unit is operable to distribute payment from said advertising source amongst a plurality of respective content sources.

29. The apparatus of claim 18, wherein said request failure analysis unit comprises a report compiler for compiling said analysis into reports for respective content sources.

30. The apparatus of claim 29, wherein said report compiler is operable to exclude from said reports data identifying individual consumers.

31. The apparatus of claim 18, wherein said request failure analysis unit is operable to use data in said analysis regarding at least one of a group comprising: geographical factors, temporal market data, pricing factors, personal data of a requesting party, network infrastructure operability in the vicinity of a requesting party, and content provider distribution factors.

32. The apparatus of claim 31, wherein said personal data of a requesting party comprises at least one of legal restrictions on said party, age related restrictions on said party, contractual restriction, risk based restrictions and content provider restrictions on said party.

33. A network content interactive packaging apparatus for suiting content to consumers, the apparatus comprising:
access to at least one content provider providing content for distribution,
access to at least one distribution node,
an input for receiving data of user requests for content including data about whether said requests have been fulfilled,
a processor, associated with said input, for analyzing failures to fulfill said requests and to use said analysis to repackage said content to minimize said failures to fulfill, or to obtain pre-repackaged content.

34. The network content interactive packaging apparatus of claim 33, wherein said processor comprises a repackager for repackaging said content, said repackager being associated with said access to said at least one distribution node, thereby being operable to repackage by instructing said distribution node in selection of content for sending to fulfill a user request.

35. The network content interactive packaging apparatus of claim 33, wherein said repackaging is provided on a per content provider basis.

36. The network content interactive packaging apparatus of claim 33, wherein said repackaging is provided on a per request basis.

37. The network content interactive packaging apparatus of claim 33, wherein said repackaging comprises editing of said content.

38. The network content interactive packaging apparatus of claim 33, wherein said repackaging comprises addition of other content to respective requested content.

39. The network content interactive packaging apparatus of claim 33, wherein said repackaging comprises addition of advertising material.

40. The network content interactive packaging apparatus of claim 33, wherein said processor further comprises a report generator for providing reports of said analysis.

41. The network content interactive packaging apparatus of claim 33, wherein said per content report generator is operable to exclude from said reports data identifying individual consumers.

42. The network content interactive packaging apparatus of claim 33, further comprising a payment receipt unit for receiving payment for said repackaged content and a payment distribution unit for distributing at least some of said payment to respective sources of said repackaged content.

43. The network content interactive packaging apparatus of claim 42, wherein said repackaging includes advertising content, said payment distribution unit being operable to direct payment from an advertising source to a respective content source.

44. The network content interactive packaging apparatus of claim 43, wherein said payment distribution unit is operable to distribute payment from said advertising source amongst a plurality of respective content sources.

45. The network distribution apparatus of claim 33, wherein said processor is operable to use, in said analysis, data regarding at least one of a group comprising: geographical factors, temporal market data, pricing factors, personal data of a requesting party, network infrastructure operability in the vicinity of a requesting party, and content provider distribution factors.

46. The network distribution apparatus of claim 45, wherein said personal data of a requesting party comprises at least one of legal restrictions on said party, age related restrictions on said party, contractual restrictions, risk based restrictions, and content provider restrictions on said party.

47. Network content distribution support method for supporting the distribution of electronic content, products or services via distribution sites over a network, the method comprising:
obtaining, via said network, from said distribution sites, information of requests for said content, products or services, including data of non-completed requests,
analyzing on line said data of non-completed requests to determine why an individual request was not completed,
offering to a requesting party an alternative to said request which overcomes a reason for non-completion determined in said analysis, and
directing, over said network, packaging and routing to said consumer of said alternative.

48. The method of claim 47, comprising providing different items of content, product or service from different data holding sites to fulfill a single request.

49. The method of claim 47, wherein distribution restrictions are associated with individual items

50. The method of claim 49, comprising providing alternatives in the event that a request coincides with a distribution restriction.

51. The method of claim 47, comprising providing information concerning requests that coincide with restrictions

52. The method of claim 47, further comprising passing payment between content distribution parties according to a contribution to a finally packaged content product as sent to a consumer.

53. The method of claim 47, further comprising using said analysis for any one of a group of uses comprises altering distribution channels, modifying a distribution policy, and modifying distribution rules.

54. The method of claim 47, further comprising at least one of correlating, gathering and weighting said details with additional information.

55. The method of claim 54, wherein said additional information comprises any one of. information about content that was actually sold, information about content that was sought, and information of content that was distributed in other ways.

56. The method of claim 47, further comprising using said analysis to evaluate existing market segmentation criteria

57. The method of claim 47, further comprising using said analysis to focus marketing efforts on potential market segments.

58. The method of claim 47, further comprising directing said analysis to unauthorized content distribution.

59. Network content distribution support method for supporting the distribution of electronic content, products or services via distribution sites over a network, the method comprising:
obtaining, from said distribution sites, information of requests for said content, products or services, including data of non-completed requests,
statistically analyzing said data of non-complicated requests taken together to determine why requests are not being completed, and
providing, results of said statistical analysis.

60. The method of claim 59, comprising providing different items of content, product or service from different data holding sites to fulfill a single request.

61. The method of claim 59, wherein distribution restrictions are associated with individual items

62. The method of claim 61, comprising providing alternatives in the event that a request coincides with a distribution restriction.

63. The method of claim 59, comprising providing information concerning requests that coincide with restrictions

64. The method of claim 59, further comprising passing payment between content distribution parties according to a contribution to a finally packaged content product as sent to a consumer.

65. The method of claim 59, further comprising using said analysis for any one of a group of uses comprises altering distribution channels, modifying a distribution policy, and modifying distribution rules.

66. The method of claim 59, further comprising at least one of correlating, gathering and weighting said details with additional information.

67. The method of claim 66, wherein said additional information comprises any one of. information about content that was actually sold, information about content that was sought, and information of content that was distributed in other ways.

68. The method of claim 59, further comprising using said analysis to evaluate existing market segmentation criteria

69. The method of claim 59, further comprising using said analysis to focus marketing efforts on potential market segments.

70. The method of claim 59, further comprising directing said analysis to unauthorized content distribution.

71. Network content distribution support method for supporting the distribution of electronic content, products or services via distribution sites over a network, the method comprising:
obtaining, via said network, from said distribution sites, information of requests for said content, products or services, including data of non-completed requests,
analyzing on line said data of non-completed requests to determine why an individual request was not completed,
offering to a requesting party an alternative to said request which overcomes a reason for non-completion determined in said analysis,
directing, over said network, the packaging and directing to said consumer of said alternative,
statistically analyzing said data of non-completed requests taken together to determine why requests are not being completed,
providing, over said network, to content providers, results of said statistical analysis.

72. The method of claim 71, comprising providing different items of content, product or service from different data holding sites to fulfill a single request.

73. The method of claim 71, wherein distribution restrictions are associated with individual items

74. The method of claim 73, comprising providing alternatives in the event that a request coincides with a distribution restriction.

75. The method of claim 71, comprising providing information concerning requests that coincide with restrictions

76. The method of claim 71, further comprising passing payment between content distribution parties according to a contribution to a finally packaged content product as sent to a consumer.

77. The method of claim 71, further comprising using said analysis for any one of a group of uses comprises altering distribution channels, modifying a distribution policy, and modifying distribution rules.

78. The method of claim 71, further comprising at least one of correlating, gathering and weighting said details with additional information.

79. The method of claim 78, wherein said additional information comprises any one of. information about content that was actually sold, information about content that was sought, and information of content that was distributed in other ways.

80. The method of claim 71, further comprising using said analysis to evaluate existing market segmentation criteria.

81. The method of claim 71, further comprising using said analysis to focus marketing efforts on potential market segments.

82. The method of claim 71, further comprising directing said analysis to unauthorized content distribution.

83. A data carrier operable with a general purpose computer to provide a network content distribution support method for supporting the distribution of electronic content, products or services via distribution sites over a network, the method comprising:
obtaining, via said network, from said distribution sites, information of requests for said content, products or services, including data of non-completed requests,
analyzing on line said data of non-completed requests to determine why an individual request was not completed,
offering to a requesting party an alternative to said request which overcomes a reason for non-completion determined in said analysis,
directing, over said network, the packaging and directing to said consumer of said alternative,
statistically analyzing said data of non-completed requests taken together to determine why requests are not being completed,
providing, over said network, to content providers, results of said statistical analysis.

84. An interface within a networked distribution arrangement, the arrangement comprising a plurality of nodes including at least two of a content source node, a monitoring node, a content distribution node and a content holding node, the interface linking at least some of said nodes and comprising consumer related details, thereby to allow distribution restriction control from each of said nodes linked by said interface.

85. The interface of claim 84, comprising a transfer mechanism operable to transfer consumer and content related details

86. The interface of claim 84, further comprising a transfer mechanism operable to transfer specific consumer related details.

87. The interface of claim 84, comprising a transfer mechanism operable to transfer specific consumer group related details.

88. The interface of claim 84, comprising a transfer mechanism operable to transfer specific consumer groups specifications.

89. The interface of claim 87, wherein said transfer is performed in response to a plurality of queries about subsets of said details.

90. The interface of claim 89, wherein said queries are performed reactively as responses to queries not relating to said details.

91. The interface of claim 89, further comprising an identification detection mechanism for detecting details that identify a consumer and suppressing said details from data to be transferred thereby to ensure that a node receiving said transfer is not provided with consumer identifying details.

92. The interface of claim 91 further comprising a transaction identification mechanism operable to identify a transaction without identifying a requesting consumer.

93. The interface of claim 92, wherein said identification mechanism is operable to utilize a temporary ID.

94. The interface of claim 93, wherein said temporary ID comprises a transaction ID.

95. The interface of claim 93, wherein said temporary ID comprises a session ID.

96. The interface of claim 84, wherein said details comprise consumer preferences.

97. The interface of claim 84, wherein said information includes consumer specific content price.

98. The interface of claim 93, wherein said details comprise consumer related restrictions.

99. The interface of claim 84, wherein said details comprise consumer specific content restrictions.

100. The interface of claim 93, wherein said details comprise consumer specific content usage preferences.

101. The interface of claim 93, wherein said details comprise consumer specific available content information.

102. The interface of claim 93, wherein said details comprise consumer specific authorized content information.

103. The interface of claim 93, wherein said details comprise consumer service information.

104. Network interactive distribution auxiliary apparatus for association with content distribution over a network from content sources in accordance with user requests to content distribution sites, said content being held in content holding sites, said apparatus comprising:
a database for holding data of placement of content around said content holding sites,
a request receiver for receiving requests for content from said content distribution sites, and
a content distribution co-ordinator, associated with said database for using said placement data to direct said data holding sites to provide content to respective requesting consumers in accordance with said requests, wherein distribution restrictions are associated with individual content items, and wherein said co-ordinator is operable to provide alternatives in the event that a request coincides with a restriction.

105. The apparatus of claim 104, wherein said co-ordinator is operable to provide different content items from different data holding sites to fulfill a single request.

106. The apparatus of claim 104, wherein said co-ordinator is operable to provide information concerning requests that coincide with restrictions.

107. The apparatus of claim 104, further comprising a payment unit for passing payment between content distribution parties according to a contribution to a finally packaged content product as sent to a consumer.

108. Network interactive distribution auxiliary apparatus for association with content distribution over a network from content sources in accordance with user requests to content distribution sites, said content being held in content holding sites, said apparatus comprising:
a database for holding data of placement of content around said content holding sites,
a request receiver for receiving requests for said placement data from said content distribution sites, and
a content distribution co-ordinator, associated with said database for sending said placement data to said distribution sites to enable said distribution sites to supply said content via said content holding sites, wherein distribution restrictions are associated with content and wherein said coordinator is operable to provide alternatives in the event that a request coincides with a restriction.

109. The apparatus of claim 108, wherein said co-ordinator is operable to provide said placement data of different content items at different data holding sites to fulfill a single request.

110. The apparatus of claim 108, wherein said co-ordinator is operable to provide information to a content source concerning requests that coincide with restrictions.

111. The apparatus of claim 108, further comprising a payment unit for passing payment between content distribution parties according to a contribution to a finally packaged content product as sent to a consumer.

112. Network interactive distribution apparatus comprising:
a content distribution site for offering a range of content items to consumers and receiving requests from consumers for said content, and
a content holding site for holding content at a location on a network and sending said content to users in response to a request from said distribution site, wherein said content distribution site is able to access data indicating, for at least some of said range of content items, a corresponding holding site holding said content, wherein at least some of said content items are associated with distribution restrictions, said distribution site comprising functionality to query a distribution restriction and to offer an alternative content item that overcomes said distribution restriction.

113. The apparatus of claim 112, wherein at least one content item is held at a plurality of said content holding sites, said distribution site comprising functionality to select a one of said holding sites being most effectively located to provide said data to a given requesting consumer.

114. The apparatus of claim 112, wherein said content holding site comprises functionality to determine that a given request requires handling by using content from a plurality of content holding sites and further comprises functionality to send requests to each of said plurality of content sites to fulfill said request.

115. Network interactive distribution auxiliary apparatus for association with content distribution over a network from content sources in accordance with user requests, the apparatus comprising:
a request gathering unit for obtaining data of user requests over a network for respective content items, said data comprising at least details of request fulfillment failures, and
a request failure analysis unit associated with said request fulfillment unit for using output of said request gathering unit to analyze said request fulfillment failures.

116. The apparatus of claim 115, further comprising a content directing unit associated with said request failure analysis unit, for directing and packaging content from at least one content source, said request failure unit further being operable to use said analysis in controlling said content directing unit to overcome said failure.

117. The apparatus of claim 116, wherein said overcoming comprises a repackaging involving respective requested content.

118. The apparatus of claim 117, wherein said repackaging comprises editing of said respective requested content.

119. The apparatus of claim 117, wherein said repackaging comprises mixing at least some of said respective requested content with other content.

120. The apparatus of claim 115, being associated with a plurality of content sources.

121. The apparatus of claim 117, wherein said repackaging comprising packaging with advertising.

122. The apparatus of claim 116, wherein said content is held at distributed locations on said network, said request failure analysis unit being operable to interact with said distributed locations to direct repackaged content to said users.

123. The apparatus of claim 122, further comprising a payment receipt unit for receiving payment for said repackaged content and a payment distribution unit for distributing at least some of said payment to respective sources of said repackaged content.

124. The apparatus of claim 123, wherein said repackaging comprises adding advertising content, said payment distribution unit being operable to direct payment from an advertising source to a respective content source.

125. The apparatus of claim 124, wherein said payment distribution unit is operable to distribute payment from said advertising source amongst a plurality of respective content sources.

126. The apparatus of claim 115, wherein said request failure analysis unit comprises a report compiler for compiling said analysis into reports for respective content sources.

127. The apparatus of claim 126, wherein said report compiler is operable to exclude from said reports data identifying individual consumers.

128. The apparatus of claim 115, wherein said request failure analysis unit is operable to use data in said analysis regarding at least one of a group comprising: geographical factors, temporal market data, pricing factors, personal data of a requesting party, network infrastructure operability in the vicinity of a requesting party, and content provider distribution factors.

129. The apparatus of claim 128, wherein said personal data of a requesting party comprises at least one of legal restrictions on said party, age related restrictions on said party, contractual restriction, risk based restrictions and content provider restrictions on said party.

130. A network content interactive packaging apparatus for suiting content to consumers, the apparatus comprising:
access to at least one content provider providing content for distribution,
access to at least one distribution node,
an input for receiving data of user requests for content including data about whether said requests have been fulfilled,
a processor, associated with said input, for analyzing failures to fulfill said requests and to use said analysis to repackage said content to minimize said failures to fulfill, or to obtain pre-repackaged content.

131. The network content interactive packaging apparatus of claim 130, wherein said processor comprises a repackager for repackaging said content, said repackager being associated with said access to said at least one distribution node, thereby being operable to repackage by instructing said distribution node in selection of content for sending to fulfill a user request.

132. The network content interactive packaging apparatus of claim 130, wherein said repackaging is provided on a per content provider basis.

133. The network content interactive packaging apparatus of claim 130, wherein said repackaging is provided on a per request basis.

134. The network content interactive packaging apparatus of claim 130, wherein said repackaging comprises editing of said content.

135. The network content interactive packaging apparatus of claim 130, wherein said repackaging comprises addition of other content to respective requested content.

136. The network content interactive packaging apparatus of claim 130, wherein said repackaging comprises addition of advertising material.

137. The network content interactive packaging apparatus of claim 130, wherein said processor further comprises a report generator for providing reports of said analysis.

138. The network content interactive packaging apparatus of claim 137 wherein said report generator is operable to exclude from said reports data identifying individual consumers.

139. The network content interactive packaging apparatus of claim 130, further comprising a payment receipt unit for receiving payment for said repackaged content and a payment distribution unit for distributing at least some of said payment to respective sources of said repackaged content.

140. The network content interactive packaging apparatus of claim 139, wherein said repackaging includes advertising content, said payment distribution unit being operable to direct payment from an advertising source to a respective content source.

141. The network content interactive packaging apparatus of claim 140, wherein said payment distribution unit is operable to distribute payment from said advertising source amongst a plurality of respective content sources.

142. The network distribution apparatus of claim 130, wherein said processor is operable to use, in said analysis, data regarding at least one of a group comprising: geographical factors, temporal market data, pricing factors, personal data of a requesting party, network infrastructure operability in the vicinity of a requesting party, and content provider distribution factors.

143. The network distribution apparatus of claim 42, wherein said personal data of a requesting party comprises at least one of legal restrictions on said party, age related restrictions on said party, contractual restrictions, risk based restrictions, and content provider restrictions on said party.

144. Network content distribution support method for supporting the distribution of electronic content, products or services via distribution sites over a network, the method comprising:
obtaining, via said network, from said distribution sites, information of requests for said content, products or services, including data of non-completed requests,
analyzing on line said data of non-completed requests to determine why an individual request was not completed,
offering to a requesting party an alternative to said request which overcomes a reason for non-completion determined in said analysis, and
directing, over said network, packaging and routing to said requesting party of said alternative.

145. The method of claim 144, comprising providing different items of content, product or service from different data holding sites to fulfill a single request.

146. The method of claim 144, wherein distribution restrictions are associated with individual items.

147. The method of claim 146, comprising providing alternatives in the event that a request coincides with a distribution restriction.

148. The method of claim 144, comprising providing information concerning requests that coincide with restrictions.

149. The method of claim 144, further comprising passing payment between content distribution parties according to a contribution to a finally packaged content product as sent to a consumer.

150. The method of claim 144, further comprising using said analysis for any one of a group of uses comprises altering distribution channels, modifying a distribution policy, and modifying distribution rules.

151. The method of claim 148, further comprising at least one of correlating, gathering and weighting said information with additional information.

152. The method of claim 151, wherein said additional information comprises any one of information about content that was actually sold, information about content that was sought, and information of content that was distributed in other ways.

153. The method of claim 144, further comprising using said analysis to evaluate existing market segmentation criteria.

154. The method of claim 144, further comprising using said analysis to focus marketing efforts on potential market segments.

155. The method of claim 144, further comprising directing said analysis to unauthorized content distribution.

156. Network content distribution support method for supporting the distribution of electronic content, products or services via distribution sites over a network, the method comprising:
obtaining, from said distribution sites, information of requests for said content, products or services, including data of non-completed requests,
statistically analyzing said data of non-completed requests taken together to determine why requests are not being completed, and
providing, results of said statistical analysis.

157. The method of claim 156, comprising providing different items of content, product or service from different data holding sites to fulfill a single request.

158. The method of claim 156, wherein distribution restrictions are associated with individual items.

159. The method of claim 158, comprising providing alternatives in the event that a request coincides with a distribution restriction.

160. The method of claim 156, comprising providing information concerning requests that coincide with restrictions

161. The method of claim 156, further comprising passing payment between content distribution parties according to a contribution to a finally packaged content product as sent to a consumer.

162. The method of claim 156, further comprising using said analysis for any one of a group of uses comprises altering distribution channels, modifying a distribution policy, and modifying distribution rules.

163. The method of claim 156, further comprising at least one of correlating, gathering and weighting details with additional information.

164. The method of claim 163, wherein said additional information comprises any one of. information about content that was actually sold, information about content that was sought, and information of content that was distributed in other ways.

165. The method of claim 156, further comprising using said analysis to evaluate existing market segmentation criteria.

166. The method of claim 156, further comprising using said analysis to focus marketing efforts on potential market segments.

167. The method of claim 156, further comprising directing said analysis to unauthorized content distribution.

168. Network content distribution support method for supporting the distribution of electronic content, products or services via distribution sites over a network, the method comprising:
obtaining, via said network, from said distribution sites, information of requests for said content, products or services, including data of non-completed requests,
analyzing on line said data of non-completed requests to determine why an individual request was not completed,
offering to a requesting party an alternative to said request which overcomes a reason for non-completion determined in said analysis,
directing, over said network, the packaging and directing to said requesting party, of said alternative,
statistically analyzing said data of non-completed requests taken together to determine why requests are not being completed,
providing, over said network, to content providers, results of said statistical analysis.

169. The method of claim 168, comprising providing different items of content, product or service from different data holding sites to fulfill a single request.

170. The method of claim 168, wherein distribution restrictions are associated with individual items.

171. The method of claim 170, comprising providing alternatives in the event that a request coincides with a distribution restriction.

172. The method of claim 168, comprising providing information concerning requests that coincide with restrictions.

173. The method of claim 168, further comprising passing payment between content distribution parties according to a contribution to a finally packaged content product as sent to a consumer.

174. The method of claim 168, further comprising using said analysis for any one of a group of uses comprises altering distribution channels, modifying a distribution policy, and modifying distribution rules.

175. The method of claim 168, further comprising at least one of correlating, gathering and weighting details with additional information.

176. The method of claim 175, wherein said additional information comprises any one of. information about content that was actually sold, information about content that was sought, and information of content that was distributed in other ways.

177. The method of claim 168, further comprising using said analysis to evaluate existing market segmentation criteria.

178. The method of claim 168, further comprising using said analysis to focus marketing efforts on potential market segments.

179. The method of claim 168, further comprising directing said analysis to unauthorized content distribution.

180. A data carrier operable with a general purpose computer to provide a network content distribution support method for supporting the distribution of electronic content, products or services via distribution sites over a network, the method comprising:
obtaining, via said network, from said distribution sites, information of requests for said content, products or services, including data of non-completed requests,
analyzing on line said data of non-completed requests to determine why an individual request was not completed,
offering to a requesting party an alternative to said request which overcomes a reason for non-completion determined in said analysis,
directing, over said network, the packaging and directing to said requesting party of said alternative,
statistically analyzing said data of non-completed requests taken together to determine why requests are not being completed,
providing, over said network, to content providers, results of said statistical analysis.

181. An interface within a networked distribution arrangement, the arrangement comprising a plurality of nodes including at least two of a content source node, a monitoring node, a content distribution node and a content holding node, the interface linking at least some of said nodes and comprising consumer related details, thereby to allow distribution restriction control from each of said nodes linked by said interface.

182. The interface of claim 181, comprising a transfer mechanism operable to transfer consumer and content related details.

183. The interface of claim 181, further comprising a transfer mechanism operable to transfer specific consumer related details.

184. The interface of claim 181, comprising a transfer mechanism operable to transfer specific consumer group related details.

185. The interface of claim 181, comprising a transfer mechanism operable to transfer specific consumer groups specifications.

186. The interface of claim 184, wherein said transfer is performed in response to a plurality of queries about subsets of said details.

187. The interface of claim 186, wherein said queries are performed reactively as responses to queries not relating to said details.

188. The interface of claim 186, further comprising an identification detection mechanism for detecting details that identify a consumer and suppressing said details from data to be transferred thereby to ensure that a node receiving said transfer is not provided with consumer identifying details.

189. The interface of claim 188 further comprising a transaction identification mechanism operable to identify a transaction without identifying a requesting consumer.

190. The interface of claim 189, wherein said identification mechanism is operable to utilize a temporary ID.

191. The interface of claim 190, wherein said temporary ID comprises a transaction ID.

192. The interface of claim 190, wherein said temporary ID comprises a session ID.

193. The interface of claim 181, wherein said details comprise consumer preferences.

194. The interface of claim 181, wherein said consumer related details include consumer specific content price.

195. The interface of claim 190, wherein said details comprise consumer related restrictions.

196. The interface of claim 181, wherein said details comprise consumer specific content restrictions.

197. The interface of claim 190, wherein said details comprise consumer specific content usage preferences.

198. The interface of claim 190, wherein said details comprise consumer specific available content information.

199. The interface of claim 190, wherein said details comprise consumer specific authorized content information.

200. The interface of claim 190, wherein said details comprise consumer service information.
